(19) United States
(12) Patent Application Publication
(10) Pub. No.: US 2024/0378348 A1
(43) Pub. Date: Nov. 14, 2024

(54) SYSTEMS AND METHODS FOR ESTIMATING VEHICLE PHYSICAL-DESIGN PARAMETERS FROM IMAGE DATA

(71) Applicant: Toyota Research Institute, Inc., Los Altos, CA (US)

(72) Inventors: Chenyang Yuan, Cambridge, MA (US); Nikos Arechiga Gonzalez, San Mateo, CA (US); Frank Permenter, Cambridge, MA (US)

(73) Assignees: Toyota Research Institute, Inc., Los Altos, CA (US); Toyota Jidosha Kabushiki Kaisha, Toyota-shi (JP)

(21) Appl. No.: 18/446,529

(22) Filed: Aug. 9, 2023

Related U.S. Application Data
(60) Provisional application No. 63/465,613, filed on May 11, 2023.
(60) Provisional application No. 63/471,389, filed on Jun. 6, 2023.

(51) Int. Cl. G06F 30/27; G06F 30/15; G06F 30/28

(52) U.S. Cl. CPC G06F 30/27; G06F 30/15; G06F 30/28

(57) ABSTRACT

Systems and methods described herein relate to estimating vehicle physical-design parameters from image data. In one embodiment, a system that estimates vehicle physical-design parameters receives one or more images representing a physical design of a vehicle. The system also processes the one or more images using a machine-learning-based model that includes a pre-trained feature extractor whose output layer has been replaced with a regression layer. The regression layer, after the regression layer has replaced the output layer, is trained to output an estimate of a physical-design parameter of the vehicle whose physical design is represented by the one or more images. The physical design of the vehicle is modified based, at least in part, on the estimate of the physical-design parameter.

### CROSS-REFERENCES TO RELATED APPLICATIONS

This application claims the benefit of U.S. Provisional Patent Application No. 63/465,613, “Surrogate Modeling of Car Drag Coefficient with Depth and Normal Renderings,” filed on May 11, 2023, and claims the benefit of U.S. Provisional Patent Application No. 63/471,389, “Systems and Methods for Drag Estimation,” filed on Jun. 6, 2023, both of which are incorporated by reference herein in their entirety.

### TECHNICAL FIELD

The subject matter described herein relates in general to the physical design of vehicles and, more specifically, to systems and methods for estimating vehicle physical-design parameters from image data.

### BACKGROUND

An important aspect of vehicle manufacturing is a vehicle's physical design (shape, structure, etc.). Modern vehicle design includes the use of sophisticated computer-aided-design (CAD) tools, and physics-based simulators permit vehicle designers to predict a vehicle's physical-design parameters such as drag coefficient from a computerized model before the vehicle is manufactured.

More recently, vehicle designers have begun to use artificial-intelligence (AI) tools to estimate vehicle physical-design parameters. For example, the drag coefficient of a vehicle can be estimated using a machine-learning-based model such as a neural network. The current technology for performing drag estimation via neural networks involves training the end-to-end network. This training process takes, as input, a computerized representation of an object such as an automobile or airplane and produces, as output, an estimated drag coefficient. The training process requires large amounts of data to train the neural network in a supervised manner, making the process both time-consuming and costly.

### SUMMARY

Embodiments of a system for estimating vehicle physical-design parameters from image data are presented herein. In one embodiment, the system comprises a processor and a memory storing machine-readable instructions that, when executed by the processor, cause the processor to receive one or more images representing a physical design of a vehicle. The memory also stores machine-readable instructions that, when executed by the processor, cause the processor to process the one or more images using a machine-learning-based model that includes a pre-trained feature extractor whose output layer has been replaced with a regression layer. The regression layer, after the regression layer has replaced the output layer, is trained to output an estimate of a physical-design parameter of the vehicle whose physical design is represented by the one or more images. The physical design of the vehicle is modified based, at least in part, on the estimate of the physical-design parameter.

Another embodiment is a non-transitory computer-readable medium for estimating vehicle physical-design parameters from image data and storing instructions that, when executed by a processor, cause the processor to receive one or more images representing a physical design of a vehicle. The instructions also cause the processor to process the one or more images using a machine-learning-based model that includes a pre-trained feature extractor whose output layer has been replaced with a regression layer. The regression layer, after the regression layer has replaced the output layer, is trained to output an estimate of a physical-design parameter of the vehicle whose physical design is represented by the one or more images. The physical design of the vehicle is modified based, at least in part, on the estimate of the physical-design parameter.

Another embodiment is a method of estimating vehicle physical-design parameters from image data, the method comprising receiving one or more images representing a physical design of a vehicle. The method also includes processing the one or more images using a machine-learning-based model that includes a pre-trained feature extractor whose output layer has been replaced with a regression layer. The regression layer, after the regression layer has replaced the output layer, is trained to output an estimate of a physical-design parameter of the vehicle whose physical design is represented by the one or more images. The physical design of the vehicle is modified based, at least in part, on the estimate of the physical-design parameter.

### BRIEF DESCRIPTION OF THE DRAWINGS

The accompanying drawings, which are incorporated in and constitute a part of the specification, illustrate various systems, methods, and other embodiments of the disclosure. It will be appreciated that the illustrated element boundaries (e.g., boxes, groups of boxes, or other shapes) in the figures represent one embodiment of the boundaries. In some embodiments, one element may be designed as multiple elements or multiple elements may be designed as one element. In some embodiments, an element shown as an internal component of another element may be implemented as an external component and vice versa. Furthermore, elements may not be drawn to scale.

FIG. 1 is a block diagram of an environment in which various embodiments of systems and methods for estimating vehicle physical-design parameters from image data can be implemented.

FIG. 2 is a block diagram of a training configuration of a system that estimates a vehicle's drag coefficient from images representing the vehicle's physical design, in accordance with an illustrative embodiment of the invention.

FIG. 3 is a block diagram of a vehicle physical-design parameter estimation system, in accordance with an illustrative embodiment of the invention.

FIG. 4 is a flowchart of a method of estimating vehicle physical-design parameters from image data, in accordance with an illustrative embodiment of the invention.

To facilitate understanding, identical reference numerals have been used, wherever possible, to designate identical elements that are common to the figures. Additionally, elements of one or more embodiments may be advantageously adapted for utilization in other embodiments described herein.

### DETAILED DESCRIPTION

Various embodiments of systems and methods for estimating vehicle physical-design parameters from image data described herein overcome the disadvantages of current machine-learning-based approaches. In the various embodiments, a vehicle physical-design parameter estimation system (hereinafter often referred to as simply a “parameter estimation system”) leverages a pre-trained (already trained) feature extractor to estimate vehicle physical-design parameters (hereinafter sometimes referred to as simply “parameters”) rather than training an end-to-end neural network. In some embodiments, the pre-trained feature extractor is a pre-trained object-classification neural network. The pre-trained feature extractor extracts, from one or more input images representing the physical design of a vehicle, a large number of intrinsic features. In the various embodiments, the final (output) layer of the pre-trained feature extractor is deleted and replaced with a regression layer that is trained to estimate a vehicle physical-design parameter such as drag coefficient based on the features extracted by the preceding layers of the pre-trained feature extractor. The regression layer can be trained using a relatively small amount of data due to the small number of trainable parameters (weights, etc.) involved.

Another significant advantage of the various embodiments described herein is that the parameter estimation system is robust against distributional shift. That is, the parameter estimation system generalizes well to out-of-distribution input image data because the pre-trained feature extractor has been trained with such a large volume and wide variety of image data.

The techniques disclosed herein can be applied to the estimation of a variety of different kinds of vehicle physical-design parameters. Examples of such parameters include, without limitation, drag coefficient (aerodynamic drag coefficient), structural strength, properties pertaining to an impact or collision with the vehicle, manufacturability (the ease with which the vehicle can be manufactured), assemblability (the ease with which the vehicle can be assembled from its constituent parts), and materials-efficiency (a measure of how much material is wasted during manufacturing).

The physical design of the vehicle can be modified based, at least in part, on the estimate of the physical-design parameter. In some embodiments, the same system that estimates the physical-design parameter modifies the physical design. In other embodiments, a component of a vehicle physical-design process modifies the physical design. In some embodiments, the parameter estimation system is part of a real-time interactive vehicle-design workflow in which a human or artificial-intelligence (AI) designer modifies the physical design of a vehicle and receives immediate feedback from the machine-learning-based model regarding how a physical-design parameter of interest changes as a result of the modifications of the physical design. This supports rapid, iterative refinement of the physical design. Conventional physics-based simulation systems require significantly more time to provide such feedback.

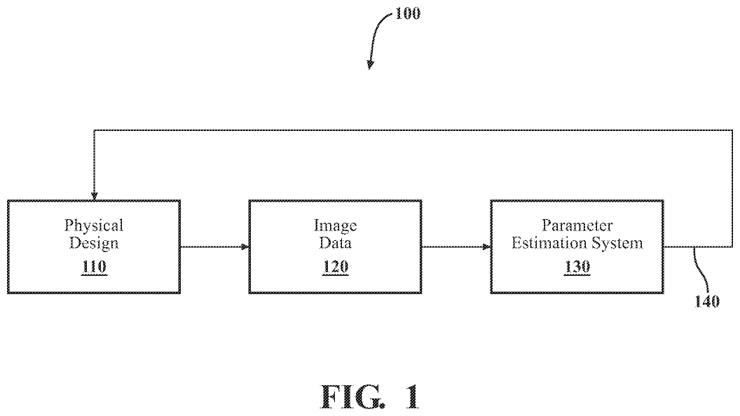

FIG. 1 is a block diagram of an environment 100 in which various embodiments of systems and methods for estimating vehicle physical-design parameters from image data can be implemented. As shown in FIG. 1, a physical-design process produces a physical design 110 of a vehicle. Herein, a “vehicle” is any form of motorized transport. One example of a “vehicle,” without limitation, is an automobile. Other examples include, without limitation, an aircraft (e.g., an airplane) and a watercraft (e.g., a boat).

The format of the physical design 110 differs, depending on the embodiment. In some embodiments, the physical design 110 is a three-dimensional (3D) model produced by a computer-aided design system or a generative AI system. In other embodiments, the physical design 110 can be, for example, computerized blueprints, two-dimensional (2D) perspective views, or 2D orthographic views.

As shown in FIG. 1, the image data 120 is generated from the physical design 110. Thus, the image data 120 represents the physical design of the vehicle for the purpose of machine-learning-based vehicle physical-design parameter estimation. The format of the image data 120 can differ, depending on the embodiment. For example, in an application in which the parameter estimation system 130 estimates the drag coefficient of a vehicle, the image data 120 might be monochromatic orthographic side, rear, and/or front views of the vehicle derived from a 3D model, since color information is not pertinent and the profile or shape of the vehicle chassis is the most important aspect of the design.

As discussed above, parameter estimation system 130 includes a machine-learning-based model that estimates a vehicle physical-design parameter by processing the image data 120. More specifically, parameter estimation system 130 includes a pre-trained feature extractor whose last (output) layer has been removed and replaced with a new regression layer. The regression layer is trained to estimate the vehicle physical-design parameter of interest based on the features extracted by the preceding layers of the pre-trained feature extractor. As mentioned above, parameter estimation system 130 leverages the ability of the pre-trained feature extractor to extract a large number of features from the image data 120 due to its having been trained on a large volume and variety of image data. By comparison, the regression layer requires a relatively small amount of training data to learn how to estimate the vehicle physical-design parameter of interest. As those skilled in the art are aware, a pre-trained feature extractor can require millions of dollars and years of compute time to produce. Some open-source pre-trained feature extractors are available to the public. As discussed above, in some embodiments, the pre-trained feature extractor is a pre-trained object-classification neural network.

As indicated in FIG. 1, in some embodiments, the parameter estimate 140 produced by parameter estimation system 130 is fed back to enable modification of the physical design 110. As mentioned above, in some embodiments, such modifications are part of an iterative process to refine the physical design 110. The techniques disclosed herein support a real-time interactive physical-design process because of the rapidity with which parameter estimation system 130 can produce a parameter estimate 140. As also noted above, a conventional physics-based simulation system requires much longer to estimate a vehicle physical-design parameter.

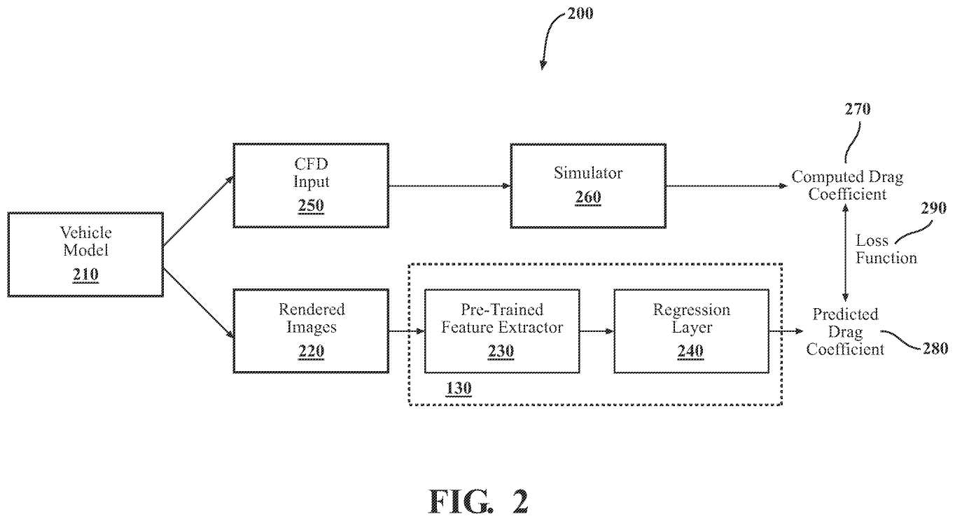

FIG. 2 is a block diagram of a training configuration 200 of a system that estimates a vehicle's drag coefficient from images 120 representing the vehicle's physical design 110, in accordance with an illustrative embodiment of the invention. In the embodiment of FIG. 2, 2D rendered images 220 (a specific type of image data 120) are generated from a vehicle model 210 (e.g., a 3D model). A pre-trained feature extractor 230 processes the rendered images 220 to extract features from the image data, as discussed above. As explained above, the output layer of the pre-trained feature extractor 230 has been deleted and replaced with a regression layer 240. The regression layer 240 is trained to output a predicted drag coefficient 280 based on the features extracted by the preceding layers of the pre-trained feature extractor 230.

As also shown in FIG. 2, during the training of the regression layer 240, computational-fluid dynamics (CFD) input 250 is generated from vehicle model 210. The CFD input 250 is input to a simulator 260 (e.g., a physics-based simulator) that, based on a mathematical model, outputs a computed drag coefficient 270 for the vehicle whose physical design is represented by the vehicle model 210 and the image data derived therefrom. The computed drag coefficient 270 serves as ground-truth data to support supervised training of regression layer 240 via a loss function 290.

In the drag-coefficient embodiment of FIG. 2, various kinds of pre-trained feature extractors 230 can be used, depending on the particular implementation. For example, the pre-trained feature extractor 230 can include, without limitation, one or more of Contrastive Language-Image Pre-Training (CLIP), a Residual Network (ResNet), a Vision Transformer (ViT), and random convolutions. In some embodiments (e.g., one employing a ResNet), the pre-trained feature extractor 230 is a pre-trained object-classification neural network.

As discussed above, the techniques disclosed herein can be applied to the estimation of a variety of other vehicle physical-design parameters besides drag coefficient, such as, without limitation, structural strength, properties pertaining to an impact or collision with the vehicle, manufacturability, assemblability, and materials-efficiency.

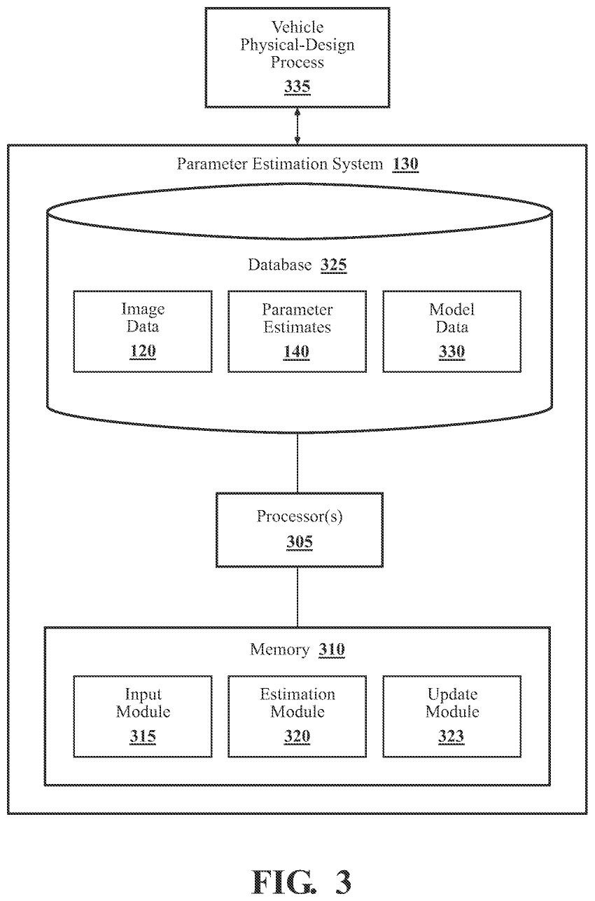

FIG. 3 is a block diagram of a parameter estimation system 130, in accordance with an illustrative embodiment of the invention. In FIG. 3, parameter estimation system 130 includes one or more processors 305 to which a memory 310 is communicably coupled. Memory 310 stores an input module 315, an estimation module 320, and an update module 323. The memory 310 is a random-access memory (RAM), read-only memory (ROM), a hard-disk drive, a flash memory, or other suitable non-transitory memory for storing the modules 315, 320, and 323. The modules 315, 320, and 323 are, for example, machine-readable instructions that, when executed by the one or more processors 305, cause the one or more processors 305 to perform the various functions disclosed herein.

As shown in FIG. 3, parameter estimation system 130 can store various kinds of data in a database 325. For example, parameter estimation system 130 can store image data 120, model data 330, and parameter estimates 140 in database 325. Model data 330 includes a variety of different kinds of data associated with the machine-learning-based model (pre-trained feature extractor 230 and regression layer 240) discussed above, including, without limitation, model parameters (weights, etc.), hyperparameters, intermediate results of computations, and training-related data. Database 325 also stores the parameter estimates 140 that the parameter estimation system 130 outputs.

As depicted in FIG. 3, parameter estimation system 130 can communicate (e.g., over a computer network) with a vehicle physical-design process 335. For example, parameter estimation system 130 can receive image data 120 from the vehicle physical-design process 335, and parameter estimation system 130 can transmit parameter estimates 140 to vehicle physical-design process 335 as part of a real-time interactive physical-design process 335, as discussed above.

Input module 315 generally includes instructions that, when executed by the one or more processors 305, cause the one or more processors 305 to receive one or more images 120 representing a physical design 110 of a vehicle. As explained above, in some embodiments, the one or more images 120 are received from a vehicle physical-design process 335. The format of the one or more images 120 can differ, depending on the embodiment (i.e., depending on the nature of the vehicle physical-design parameter to be estimated). Regardless of the specific format, the one or more images 120 represent the physical design 110 of a vehicle.

Estimation module 320 generally includes instructions that, when executed by the one or more processors 305, cause the one or more processors 305 to process the one or more images 120 using a machine-learning-based model that includes a pre-trained feature extractor 230 whose output layer has been replaced with a regression layer 240. As discussed above, after the output layer of pre-trained feature extractor 230 has been replaced with regression layer 240, the regression layer 240 is trained to output an estimate 140 of a physical-design parameter of the vehicle whose physical design 110 is represented by the one or more images 120. In the embodiment of FIG. 3, estimation module 320 thus corresponds to the machine-learning-based model discussed above.

As discussed above, in some embodiments, the physical design 110 of the vehicle is modified based, at least in part, on the estimate 140 of the physical-design parameter output by the parameter estimation system 130. In some embodiments, update module 323 includes instructions that, when executed by the one or more processors 305, cause the one or more processors 305 to modify the physical design 110 based, at least in part, on the estimate 140 of the physical-design parameter. For example, update module 323 might modify the physical design 110 in a way that improves the physical-design parameter estimated by parameter estimation system 130. This can be confirmed through an updated estimate 140 of the relevant parameter based on the modified physical design 110. In other embodiments, a component of vehicle physical-design process 335 modifies physical design 110 based, at least in part, on the estimate 140 of the physical-design parameter. In some embodiments, parameter estimation system 130 is part of a real-time interactive vehicle physical-design process 335. In such an embodiment, a human or AI designer might modify the physical design 110 of the vehicle and receive immediate feedback from the machine-learning-based model regarding how a physical-design parameter of interest (e.g., drag coefficient) changes as a result of the modifications of the physical design 110. This facilitates an iterative process of refining the physical design 110.

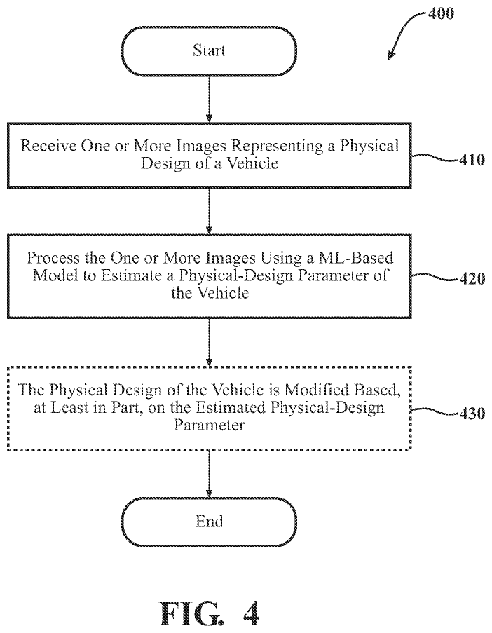

FIG. 4 is a flowchart of a method 400 of estimating vehicle physical-design parameters from image data 120, in accordance with an illustrative embodiment of the invention. Method 400 will be discussed from the perspective of parameter estimation system 130 in FIG. 3. While method 400 is discussed in combination with parameter estimation system 130, it should be appreciated that method 400 is not limited to being implemented within parameter estimation system 130, but parameter estimation system 130 is instead one example of a system that may implement method 400.

At block 410, input module 315 receives one or more images 120 representing a physical design 110 of a vehicle. As explained above, in some embodiments, the one or more images 120 are received from a vehicle physical-design process 335. The format of the one or more images 120 can differ, depending on the embodiment (i.e., depending on the nature of the vehicle physical-design parameter to be estimated). Regardless of the specific format, the one or more images 120 represent the physical design 110 of a vehicle.

At block 420, estimation module 320 processes the one or more images 120 using a machine-learning-based model that includes a pre-trained feature extractor 230 whose output layer has been replaced with a regression layer 240. As discussed above, after the output layer of pre-trained feature extractor 230 has been replaced with regression layer 240, the regression layer 240 is trained to output an estimate 140 of a physical-design parameter of the vehicle whose physical design 110 is represented by the one or more images 120. As discussed above, in some embodiments, the pre-trained feature extractor 230 is a pre-trained object-classification neural network. As discussed in connection with the drag-coefficient-estimation embodiment of FIG. 2, the pre-trained feature extractor 230 can include, without limitation, one or more of CLIP, a ResNet, a ViT, and random convolutions.

At block 430, the physical design 110 of the vehicle is modified based, at least in part, on the estimate 140 of the physical-design parameter. As discussed above, in some embodiments, update module 323 in parameter estimation system 130 modifies the physical design 110. In other embodiments, a component of vehicle physical-design process 335 modifies the physical design 110. In some embodiments, parameter estimation system 130 is part of a real-time interactive vehicle physical-design process 335 in which a human or AI designer modifies the physical design 110 of the vehicle and receives immediate feedback from the machine-learning-based model regarding how a physical-design parameter of interest (e.g., drag coefficient) changes as a result of the modifications of the physical design 110. This supports rapid, iterative refinement of the physical design 110.

As discussed above, the techniques disclosed herein can be applied to the estimation of a variety of other vehicle physical-design parameters besides drag coefficient, such as, without limitation, structural strength, properties pertaining to an impact or collision with the vehicle, manufacturability, assemblability, and materials-efficiency.

Detailed embodiments are disclosed herein. However, it is to be understood that the disclosed embodiments are intended only as examples. Therefore, specific structural and functional details disclosed herein are not to be interpreted as limiting, but merely as a basis for the claims and as a representative basis for teaching one skilled in the art to variously employ the aspects herein in virtually any appropriately detailed structure. Further, the terms and phrases used herein are not intended to be limiting but rather to provide an understandable description of possible implementations. Various embodiments are shown in FIGS. 1-4, but the embodiments are not limited to the illustrated structure or application.

The components described above can be realized in hardware or a combination of hardware and software and can be realized in a centralized fashion in one processing system or in a distributed fashion where different elements are spread across several interconnected processing systems. A typical combination of hardware and software can be a processing system with computer-usable program code that, when being loaded and executed, controls the processing system such that it carries out the methods described herein. The systems, components and/or processes also can be embedded in a computer-readable storage, such as a computer program product or other data programs storage device, readable by a machine, tangibly embodying a program of instructions executable by the machine to perform methods and processes described herein. These elements also can be embedded in an application product which comprises all the features enabling the implementation of the methods described herein and, which when loaded in a processing system, is able to carry out these methods.

Furthermore, arrangements described herein may take the form of a computer program product embodied in one or more computer-readable media having computer-readable program code embodied, e.g., stored, thereon. Any combination of one or more computer-readable media may be utilized. The computer-readable medium may be a computer-readable signal medium or a computer-readable storage medium. The phrase “computer-readable storage medium” means a non-transitory storage medium. A computer-readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer-readable storage medium would include the following: a portable computer diskette, a hard disk drive (HDD), a solid-state drive (SSD), a read-only memory (ROM), an erasable programmable read-only memory (EPROM or Flash memory), a portable compact disc read-only memory (CD-ROM), a digital versatile disc (DVD), an optical storage device, a magnetic storage device, or any suitable combination of the foregoing. In the context of this document, a computer-readable storage medium may be any tangible medium that can contain or store a program for use by or in connection with an instruction execution system, apparatus, or device.

Program code embodied on a computer-readable medium may be transmitted using any appropriate medium, including but not limited to wireless, wireline, optical fiber, cable, RF, etc., or any suitable combination of the foregoing. Computer program code for carrying out operations for aspects of the present arrangements may be written in any combination of one or more programming languages, including an object-oriented programming language such as Java™, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer, or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Generally, “module,” as used herein, includes routines, programs, objects, components, data structures, and so on that perform particular tasks or implement particular data types. In further aspects, a memory generally stores the noted modules. The memory associated with a module may be a buffer or cache embedded within a processor, a RAM, a ROM, a flash memory, or another suitable electronic storage medium. In still further aspects, a module as envisioned by the present disclosure is implemented as an application-specific integrated circuit (ASIC), a hardware component of a system on a chip (SoC), as a programmable logic array (PLA), or as another suitable hardware component that is embedded with a defined configuration set (e.g., instructions) for performing the disclosed functions.

The terms “a” and “an,” as used herein, are defined as one or more than one. The term “plurality,” as used herein, is defined as two or more than two. The term “another,” as used herein, is defined as at least a second or more. The terms “including” and/or “having,” as used herein, are defined as comprising (i.e. open language). The phrase “at least one of . . . and . . . ” As used herein refers to and encompasses any and all possible combinations of one or more of the associated listed items. As an example, the phrase “at least one of A, B, and C” includes A only, B only, C only, or any combination thereof (e.g. AB, AC, BC or ABC).

As used herein, “cause” or “causing” means to make, command, instruct, and/or enable an event or action to occur or at least be in a state where such event or action may occur, either in a direct or indirect manner.

Aspects herein can be embodied in other forms without departing from the spirit or essential attributes thereof. Accordingly, reference should be made to the following claims rather than to the foregoing specification, as indicating the scope hereof.

What is claimed is:

1. A system for estimating vehicle physical-design parameters from image data, the system comprising:
a processor; and
a memory storing machine-readable instructions that, when executed by the processor, cause the processor to:
receive one or more images representing a physical design of a vehicle; and
process the one or more images using a machine-learning-based model that includes a pre-trained feature extractor whose output layer has been replaced with a regression layer, wherein the regression layer, after the regression layer has replaced the output layer, is trained to output an estimate of a physical-design parameter of the vehicle whose physical design is represented by the one or more images;
wherein the physical design of the vehicle is modified based, at least in part, on the estimate of the physical-design parameter.

2. The system of claim 1, wherein the physical-design parameter is a drag coefficient.

3. The system of claim 2, wherein two-dimensional (2D) computational-fluid dynamics (CFD) simulations are used to generate ground-truth drag-coefficient data for training the regression layer to estimate the drag coefficient.

4. The system of claim 1, wherein the physical-design parameter is one of structural strength, a property relating to an impact with the vehicle, manufacturability, assemblability, and materials-efficiency.

5. The system of claim 1, wherein the pre-trained feature extractor is a pre-trained object-classification neural network.

6. The system of claim 1, wherein the pre-trained feature extractor includes one or more of Contrastive Language-Image Pre-Training (CLIP), a Residual Network (ResNet), a Vision Transformer (ViT), and random convolutions.

7. The system of claim 1, wherein the machine-readable instructions to process the one or more images and modify the physical design support a real-time interactive vehicle-design workflow in which a designer modifies the physical design and receives feedback from the machine-learning-based model regarding how the physical-design parameter changes as a result of one or more modifications of the physical design.

8. A non-transitory computer-readable medium for estimating vehicle physical-design parameters from image data and storing instructions that, when executed by a processor, cause the processor to:
receive one or more images representing a physical design of a vehicle; and
process the one or more images using a machine-learning-based model that includes a pre-trained feature extractor whose output layer has been replaced with a regression layer, wherein the regression layer, after the regression layer has replaced the output layer, is trained to output an estimate of a physical-design parameter of the vehicle whose physical design is represented by the one or more images;
wherein the physical design of the vehicle is modified based, at least in part, on the estimate of the physical-design parameter.

9. The non-transitory computer-readable medium of claim 8, wherein the physical-design parameter is a drag coefficient.

10. The non-transitory computer-readable medium of claim 9, wherein two-dimensional (2D) computational-fluid dynamics (CFD) simulations are used to generate ground-truth drag-coefficient data for training the regression layer.

11. The non-transitory computer-readable medium of claim 8, wherein the physical-design parameter is one of structural strength, a property relating to an impact with the vehicle, manufacturability, assemblability, and materials-efficiency.

12. The non-transitory computer-readable medium of claim 8, wherein the pre-trained feature extractor is a pre-trained object-classification neural network.

13. The non-transitory computer-readable medium of claim 8, wherein the processing and the modifying are part of a real-time interactive vehicle-design workflow in which a designer modifies the physical design and receives feedback from the machine-learning-based model regarding how the physical-design parameter changes as a result of one or more modifications of the physical design.

14. A method, comprising:
receiving one or more images representing a physical design of a vehicle; and
processing the one or more images using a machine-learning-based model that includes a pre-trained feature extractor whose output layer has been replaced with a regression layer, wherein the regression layer, after the regression layer has replaced the output layer, is trained to output an estimate of a physical-design parameter of the vehicle whose physical design is represented by the one or more images;
wherein the physical design of the vehicle is modified based, at least in part, on the estimate of the physical-design parameter.

15. The method of claim 14, wherein the physical-design parameter is a drag coefficient.

16. The method of claim 15, wherein two-dimensional (2D) computational-fluid dynamics (CFD) simulations are used to generate ground-truth drag-coefficient data for training the regression layer to estimate the drag coefficient.

17. The method of claim 14, wherein the physical-design parameter is one of structural strength, a property relating to an impact with the vehicle, manufacturability, assemblability, and materials-efficiency.

18. The method of claim 14, wherein the pre-trained feature extractor is a pre-trained object-classification neural network.

19. The method of claim 14, wherein the pre-trained feature extractor includes one or more of Contrastive Language-Image Pre-Training (CLIP), a Residual Network (ResNet), a Vision Transformer (ViT), and random convolutions.

20. The method of claim 14, wherein the processing and the modifying are part of a real-time interactive vehicle-design workflow in which a designer modifies the physical design and receives feedback from the machine-learning-based model regarding how the physical-design parameter changes as a result of one or more modifications of the physical design.
